(19) United States
(12) Patent Application Publication
(10) Pub. No.: US 2005/0153083 A1
(43) Pub. Date: Jul. 14, 2005

(54) Flat bonding wrapping film

(76) Inventor: Nan-Yuan Huang, Hsinchu (TW)

Correspondence Address: BIRCH STEWART KOLASCH & BIRCH, PO BOX 747, FALLS CHURCH, VA, 22040-0747, US

(21) Appl. No.: 10/753,416

(22) Filed: Jan. 9, 2004

(51) Int. Cl. F16B 4/00

(52) U.S. Cl. 428/34.9

(57) ABSTRACT

A flat bonding wrapping film has two or more strips of double-sided adhesive bonded thereon at an interval according to the requirement of a goods to be wrapped. The wrapping film is cut into individual pieces and stacked. The wrapping film has the double-sided adhesive bonded on one side and another side overlapping and bonding to the one side thereof. The wrapped goods is heated in a heating apparatus to wrap the wrapping film on the goods to achieve fast, convenient and simple bonding.

### FIELD OF THE INVENTION

The present invention relates to a flat bonding wrapping film and particularly to a wrapping film that is convenient to use, simple to operate and allows fast bonding.

### BACKGROUND OF THE INVENTION

The wrapping film now being used generally is fabricated at a required length and coupled on goods to be wrapped then is glued with adhesive at an overlapped portion on two sides of wrapping film to bond the goods. The wrapping method mentioned above has drawbacks, notably:
1. The amount of adhesive to be used for bonding is difficult to control and often results in uneven bonding.

Too much adhesive will result in poor aesthetic appearance. Too little adhesive will result in not strong bonding and peeling off of the wrapping film.
2. The adhesive usually is water solvable. Thus when in contact with water, the wrapping film is prone to peel off or skew, and the aesthetic appealing is affected.

### SUMMARY OF THE INVENTION

In view of the aforesaid disadvantages, the invention aims to provide a simple flat bonding wrapping film that has one surface bonded with double-sided adhesive. The wrapping film has one side bonding to an overlapped area on another side thereof so that the wrapping film covers a goods to be wrapped.

The wrapping film may be a shrinkable film (i.e. films made from OPS, PE) or a non-shrinkable film (i.e. a blister sheet made from PVC, PET, OPP, PP). The wrapping film is fabricated at a length according to the bonding requirement of the goods to be wrapped. The number of strips of the bonded double-sided adhesive on one surface is greater than or equal to two. The wrapping film made of a shrinkable film is processed in a heating apparatus to shrink the wrapping film and bond the goods tightly to form a flat bonding structure.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the present invention.

FIG. 2 is an exploded view of the present invention being cut and stacked, and rolled in a barrel.

FIG. 3 is a schematic view of the present invention with the double-sided adhesive being peeled off.

FIG. 4A is a top view of the wrapping film prior to bonding.

FIG. 4B is a top view of the wrapping film with one side bonded.

FIG. 4C is a top view of the wrapping film wrapping a goods.

FIG. 4D is a top view of the wrapping film in a bonded condition.

FIG. 5 is a schematic view of a goods covered by the wrapping film and shrink-wrapped by a heating apparatus.

FIG. 6 is a schematic view of a second embodiment of the wrapping film bonding with a double-sided adhesive.

### DETAILED DESCRIPTION OF THE PREFERRED EMBODIMENTS

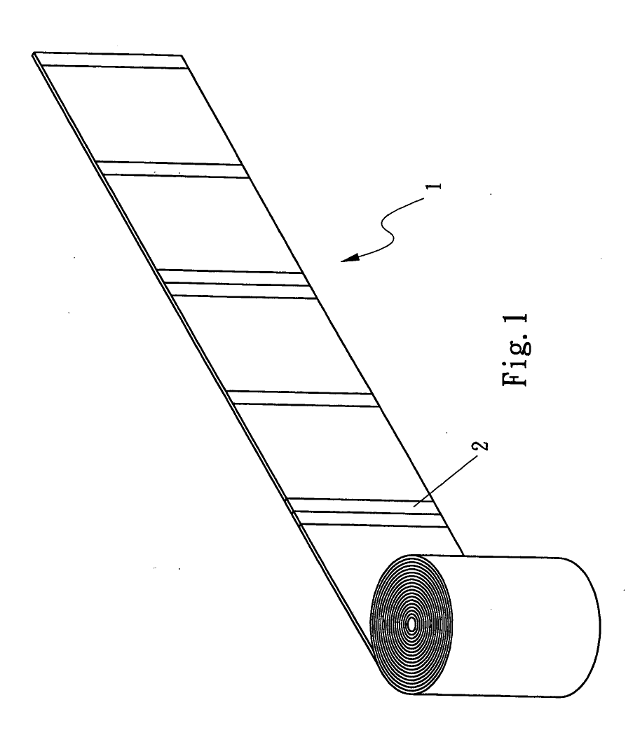

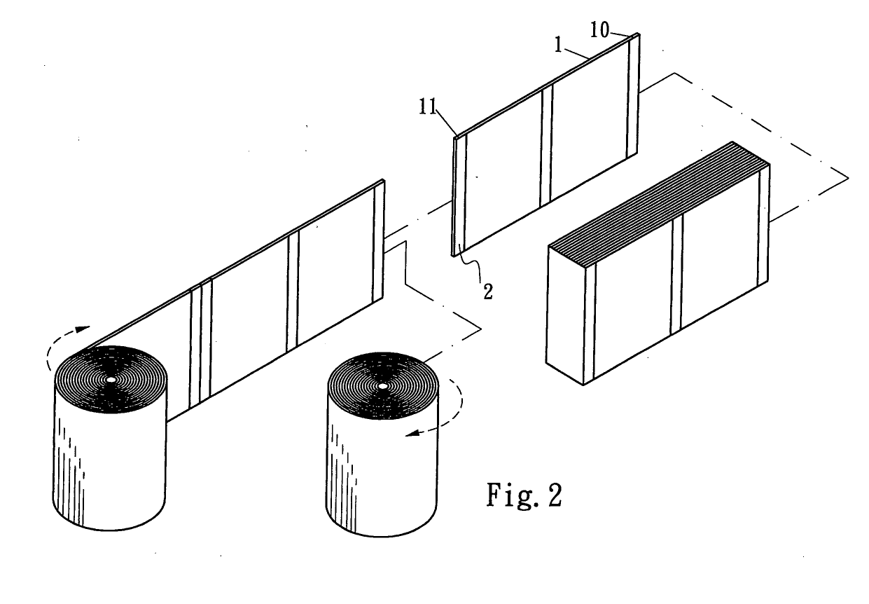

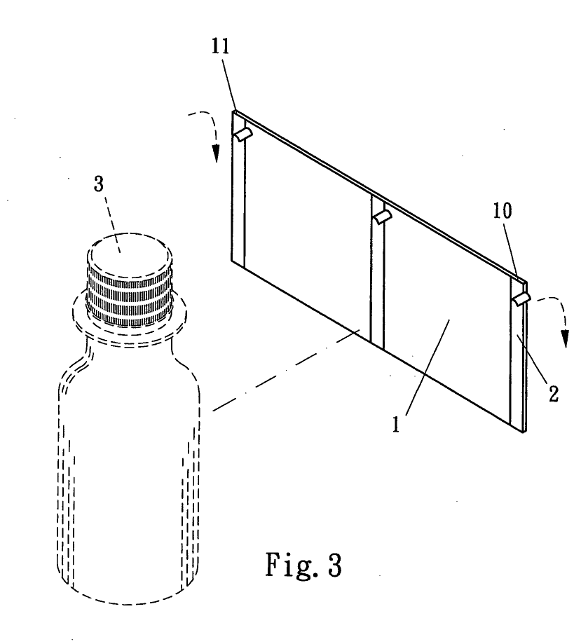

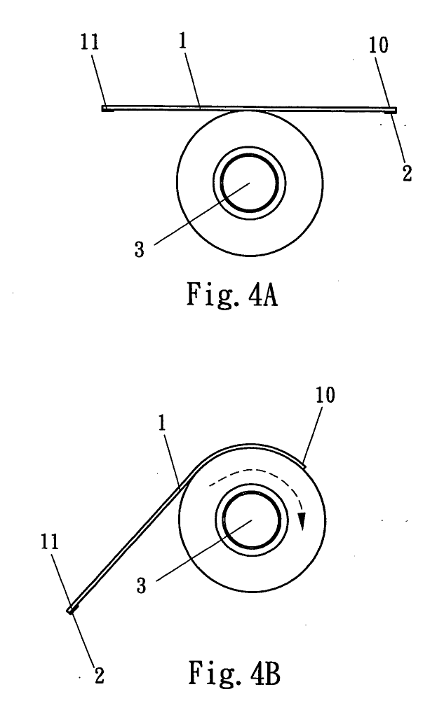

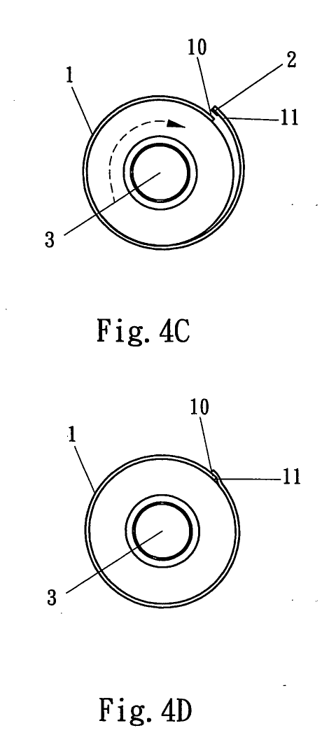

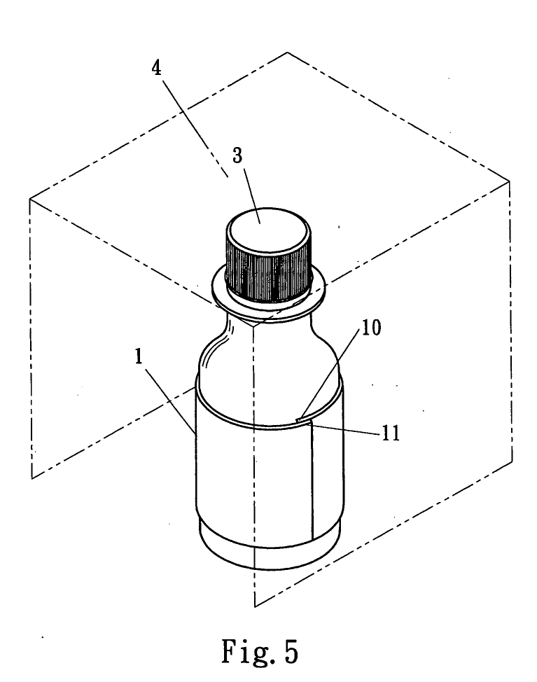

Please referring to FIG. 1 and FIG. 3, the flat wrapping film according to the invention includes a wrapping film 1 and a double-sided adhesive 2. The wrapping film 1 has two or more strips of the double-sided adhesive 2 bonded thereon at an interval according to a goods 3 to be wrapped. In this embodiment, three strips are provided. It may be cut to individual wrapping film 1 and stacked as shown in FIG. 2, or the wrapping film 1 with the double-sided adhesive 2 bonded thereon may be rolled in a barrel as shown in FIGS. 3 and 4A. For bonding, peel off the double-sided adhesive 2, bond one side 10 of the wrapping film 1 on the goods 3 to be wrapped (referring to FIG. 4B), then turn the goods 3 to place another side 11 of the wrapping film 1 overlapping the one side 10 to wrap up the goods and form a bonding (referring to FIGS. 4C and 4D). Then the wrapped goods is placed in a heating apparatus 4 to make the wrapping film 1 to be shrink-wrapped tightly on the goods 3 (referring to FIG. 5).

The wrapping film 1 may be made from a shrinkable film such as OPS or PE, or a non-shrinkable film such as PVC, PET, OPP, or PP. When the wrapping film 1 is made from a non-shrinkable film and wrapped on the goods 3, it does not need to be heated in the heating apparatus 4. The wrapping film 1 may be directly bonded on the surface of the goods 3.

The double-sided adhesive 2 is a sticky substance with bonding power on two sides to match the wrapping film 1.

The length of the wrapping film 1 is determined according to the goods 3 to be wrapped.

The heating apparatus 4 can shrink the wrapping film 1 tightly on the surface of the goods 3 to be wrapped.

Referring to FIG. 1 and FIG. 3, when a shrinkable film is used, the wrapping film 1 has two or more strips of the double-sided adhesive 2 spaced and bonded at an interval according to the requirement of the goods 3. The film may be cut into individual pieces and stacked as shown in FIG. 2. Or the wrapping film 1 bonded with the double-sided adhesive 2 may be rolled into a barrel. For bonding, peel off the double-sided adhesive 2 (referring to FIGS. 3 and 4A), bond one side 10 of the wrapping film 1 on the goods 3 to be wrapped (referring to FIG. 4B), then turn the goods 3 to place another side 11 of the wrapping film 1 to overlap the one side 10 to form a bonding (referring to FIGS. 4C and 4D). Then the wrapped goods is placed in a heating apparatus 4 to make the wrapping film 1 to be shrink-wrapped tightly on the goods 3 (referring to FIG. 5).

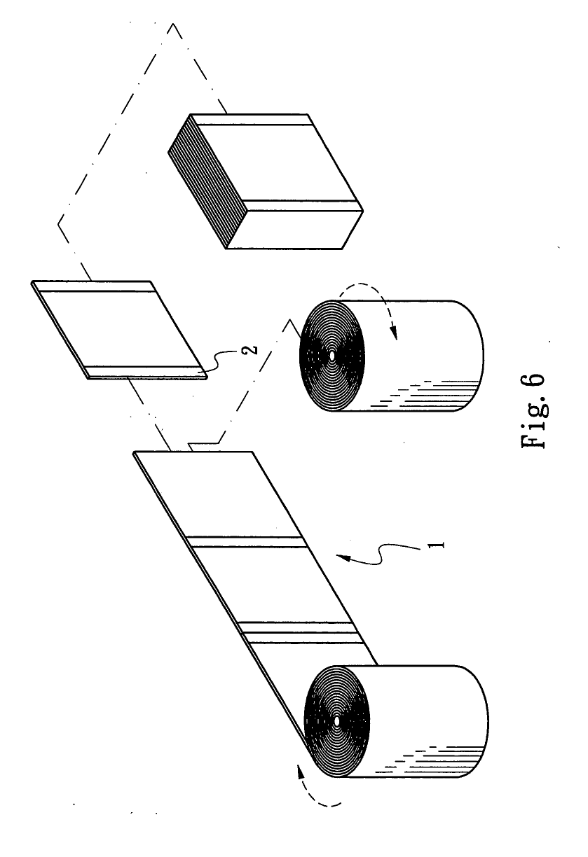

Refer to FIG. 6 for a second embodiment of the invention. It is substantially like the one shown in FIG. 1. The difference is that the wrapping film 1 has two sides bonded with the double-sided adhesive 2 according to the size of the goods 3 to be wrapped.

1. A flat bonding wrapping film comprising a wrapping film and a double-sided adhesive bonding on one surface of the wrapping film, the wrapping film having one side bonding to another side thereof which overlaps the one side to cover a goods to be wrapped thereby to achieve fast, convenient and simple wrapping effect.

2. The flat bonding wrapping film of claim 1, wherein the wrapping film is selectively a shrinkable film or a non-shrinkable film.

3. The flat bonding wrapping film of claim 2, wherein the wrapping film is made from a shrinkable film and processed in a heating apparatus to form a flat bonding structure.

4. The flat bonding wrapping film of claim 2, wherein the shrinkable film is made from OPS or PE.

5. The flat bonding wrapping film of claim 2, wherein the non-shrinkable film is made from PVC, PET, OPP or PP.

6. The flat bonding wrapping film of claim 1, wherein the double-sided adhesive bonded on the one surface of the wrapping film has two strips.

7. The flat bonding wrapping film of claim 1, wherein the double-sided adhesive bonded on the one surface of the wrapping film has more than two strips.
